(19) United States
(12) Patent Application Publication
(10) Pub. No.: US 2006/0293945 A1
(43) Pub. Date: Dec. 28, 2006

(54) Method and device for building and using table of reduced profiles of paragons and corresponding computer program

(75) Inventors: Raphael Feraud, Perros Guirec (FR); Fabrice Clerot, Louannec (FR); Marc Boulle, Tregastel (FR); Aurelie Le Cam, Lannion (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: France Telecom, Paris (FR)

(21) Appl. No.: 11/441,277

(22) Filed: May 25, 2006

(30) Foreign Application Priority Data
May 27, 2005 (FR) 05/05412

(51) Int. Cl. G06F 17/30

(52) U.S. Cl. 705/10

(57) ABSTRACT

A method for the building and use of a table of reduced profiles of paragons enables the summarizing of a table of profiles of a set of individuals, all the profiles being defined by a same set of indicators, the profile of a given individual comprising values for said set of indicators that are proper to said given individual. The method comprises the following steps: the selecting, from the set of indicators, of a subset of indicators defining reduced profiles of individuals, the reduced profile of a given individual comprising values for said subset of indicators that are proper to said given individual and obtained from data of a data warehouse; the sampling of the set of individuals, enabling a sample of individuals called paragons to be obtained; the obtaining of a table of reduced profiles of paragons comprising, for each of the paragons, a reduced profile specific to said paragons; and the indexing of all the individuals to the paragons, making it possible to obtain an index linking each individual to at least one paragon whose reduced profile is closest to the reduced profile of said individual, so that the content of the table of reduced profiles of paragons can be used for all the individuals.

### CROSS-REFERENCE TO RELATED APPLICATION

None.

### FIELD OF THE DISCLOSURE

The field of the disclosure is that of decision-related information technology, i.e. business intelligence, and more specifically that of data-mining.

Data-mining can be used to convert the different data sources of a company (customer-related, traffic-related, textual, multimedia and other data) into exploitable knowledge. In other words, data exploration covers all the techniques by which it is possible to enrich and exploit the data of the company in order to achieve an operational goal. The models produce scores and/or segments from profiles of individuals. A score is defined as the result of a model aimed at forecasting or estimating a characteristic of a customer, such as loyalty, appetence, etc. A segment is defined as a set of individuals having similar behavior and characteristics.

The profile of an individual is a set of indicators (common to the profiles of all individuals of the population concerned) whose values are computed from the detailed data of a data warehouse and by which an individual can be characterized.

An individual is, for example, a customer, a product, a communications call, an IP address etc. or more generally any element that can be processed as an independent unit or as a member of a special category, and on which data can be stored.

More specifically, the disclosure relates to a technique for building and using a table of reduced profiles of paragons, that enables a table of profiles of a set of individuals to be summarized.

A “paragon” is defined an individual whose behavior and characteristics represent a set of individuals.

A “reduced profile” or again a signature is defined as a subset of indicators of the profile such as developing loyalty, ADSL appetence, sizing a telecom network and the like, dedicated to a particular professional domain.

One or more embodiments of the invention can be applied especially but not exclusively to the deployment of models built from several tens of thousands of indicators on several tens of millions of individuals.

### BACKGROUND OF THE DISCLOSURE

The items of data coming from the information system of a company are consolidated in data warehouses. Profiles are then computed from the details constituting the data to characterize the customers, products, transactions etc.

Data-mining techniques enable these profiles to be extracted from objective and quantitative elements such as for example appetence to a service. To build and deploy scores, the usual technique comprises two steps:

Step 1: a sampling of individuals is drawn from the data warehouse (database). A profile is built for each individual from the detailed data contained in the database. The predictive model is built from the profiles of individuals of the sample. The bigger the sample, the more precise the model, but the costlier will its construction be in terms of time and computer resources.

Step 2: the model obtained must then be applied sequentially to the profile of each individual to compute its score. So much so that, to deploy a model, it is necessary to build and feed a datamart corresponding to the table of profiles of all the individuals.

One drawback of the prior art technique is that step 2 is obviously very costly since it is a full-fledged computer project.

Another drawback of the prior art technique is that the system has very low open-endedness since each addition or change of indicators means modifying the entire feeding of the datamart.

Yet another drawback of the prior art is that it limits the expansion of the size of the profiles whereas the richer the profiles in information the greater is the knowledge of the objects studied and the better the performance of the models producing the scores. Indeed, the models must be deployed in the (IS) Information System so that the scores can be exploited by other applications. But the greater the number of indicators constituting the profiles, the costlier is this deployment in terms of technical architecture and maintenance.

### SUMMARY OF THE DISCLOSURE

An embodiment of the present invention is directed to a method for the building and use of a table of reduced profiles of paragons that enables the summarizing of a table of profiles of a set of individuals, all the profiles being defined by a same set of indicators, the profile of a given individual comprising values for said set of indicators that are proper to said given individual, said method comprising the following steps:
the selecting, from the set of indicators, of a subset of indicators defining reduced profiles of individuals, the reduced profile of a given individual comprising values for said subset of indicators that are proper to said given individual and obtained from data of a data warehouse;
the sampling of the set of individuals, enabling a sample of individuals called paragons to be obtained;
the obtaining of a table of reduced profiles of paragons comprising, for each of the paragons, a reduced profile specific to said paragons; and
the indexing of all the individuals to the paragons, making it possible to obtain an index linking each individual to at least one paragon whose reduced profile is closest to the reduced profile of said individual, so that the content of the table of reduced profiles of paragons can be used for all the individuals.

There are many methods that can be used to select variables, take samples or carry out indexing. The originality of the approach of an embodiment of the invention lies in the combination of these selection, sampling and indexing algorithms to produce a table of reduced profiles (signatures) of paragons that summarizes the full table of the profiles, and is dynamically linked to this table. Thus, as described in detail here below, each score and/or segment produced on the paragons can be generalized to all the individuals. The technique of the invention enables the processing of a potentially huge volume (the complete table of the profiles) on a very small volume (the table of the reduced profiles of the paragons).

An embodiment of the invention includes the extraction, from a data warehouse, of a table of reduced profiles of paragons comprising solely of the relevant indicators and the most representative individuals (customers, products, transactions etc.) This table of reduced profiles of paragons is connected to the complete base by an automatically maintained index.

The technique can have many advantages over the standard technique:
in working on a table of reduced profiles of paragons and not on a datamart corresponding to a table of profiles of all the individuals, the technique of the invention reduces deployment, storage and data-handling costs;
the table of the paragons is smaller by a factor of 1000 than the standard datamart corresponding to the table of profiles of all the individuals, and the cost of storage and supply is reduced accordingly;
contrary to a classic sample, the paragons are related to the individuals that they represent, so much so that the deployment of a model in this case comprises of a simple joining;
the paragons, being true individuals, develop naturally and can be representative of the population in the course of time;
   the table of paragons is generated automatically from the data warehouse, so much so that the system is highly open-ended and costs very little to maintain as compared with a classic datamart corresponding to a table of profiles of all the individuals.
   Advantageously, the sampling step is performed as a function of the result of the selection step, so that the paragons represent all the individuals in said subset of indicators.

In a first particular embodiment of the invention, the step of selection of a subset of indicators comprises a step for obtaining a predetermined list of pre-selected indicators.

Thus, the indicators (also called variables or attributes) characterizing the table of reduced profiles of paragons may be selected in advance as a function of a profession-related goal. This enables the building of a representative sample on the variables that are useful for the goal fixed.

It will be noted that this first embodiment uses no target variable. This corresponds for example to a methodology of the type that can be used to obtain segments (by exploratory analysis).

In a second particular embodiment of the invention, the step of selection of a subset of indicators comprises a step of computation of the subset of indicators as a function of at least one determined target indicator.

In other words, one or more target variables are used. This corresponds for example to a methodology of the type that can be used to obtain scores or a methodology of the type that can be used to obtain segments (by exploratory analysis).

Advantageously, the method furthermore comprises a step for building at least one analysis model based on the table of reduced profiles of paragons.

Advantageously, the method furthermore comprises a step of deployment of a model of analysis, itself comprising the following steps:
obtaining scores and/or segments for the paragons from the table of reduced profiles of paragons;
the generalizing, to all the individuals, of the scores and/or segments obtained for the paragon, through said index.

Advantageously, the selection step implements an algorithm enabling the processing of data from the data warehouse by sections of columns and the sampling and indexing steps implement algorithms enabling the processing of data from the data warehouse by sections of rows.

An embodiment of the invention also relates to a computer program product that can be downloaded from a communications network and/or recorded in a computer-readable carrier and/or executed by a processor. This computer program product comprises program code instructions for the execution of above-mentioned method according to an embodiment of the invention, when said program is executed on a computer.

An embodiment of the invention also relates to a device for the building and use of a table of reduced profiles of paragons that enables the summarizing of a table of profiles of a set of individuals, all the profiles being defined by a same set of indicators, the profile of a given individual comprising values for said set of indicators that are proper to said given individual, said device comprising:
selection means enabling the selection, from the set of indicators of a subset of indicators defining reduced profiles of individuals, the reduced profile of a given individual comprising values for said subset of indicators that are proper to said given individual and obtained from the data of a data warehouse;
means for sampling the set of individuals, enabling a sample of individuals called paragons to be obtained;
means for obtaining a table of reduced profiles of paragons comprising, for each of the paragons, a reduced profile specific to said paragon; and
means for indexing all the individuals to the paragons, making it possible to obtain an index linking each individual to at least one paragon whose reduced profile is the closest to the reduced profile of said individual, so that the content of the table of reduced profiles of paragons can be used for all the individuals.

Other features and advantages shall appear from the following description of an embodiment of the invention, given by way of a non-restrictive indication and from the appended drawings.

### BRIEF DESCRIPTION OF THE DRAWINGS

FIG. 1 is a flow chart of particular embodiment of the method for the building and use of a table of reduced profiles of paragons;

FIG. 2 presents a functional architecture illustrating the application of the method to the analysis of customer data;

FIG. 3 illustrates the principle of the building of a table of reduced profiles of paragons according to an embodiment;

FIG. 4 presents an architecture of the processing operations performed according to an embodiment for building a table of reduced profiles of paragons; and

FIG. 5 shows a structure of the device according to an embodiment, enabling the building and use of a table of reduced profiles of paragons.

### DETAILED DESCRIPTION OF ILLUSTRATIVE EMBODIMENTS

An embodiment of the invention therefore relates to a method for the building and use of a table of reduced profiles of paragons by which a table of profiles of a set of individuals can be summarized.

The profiles are all defined by a same set of indicators. The profile of a given individual includes values for the set of indicators that are proper to this given individual.

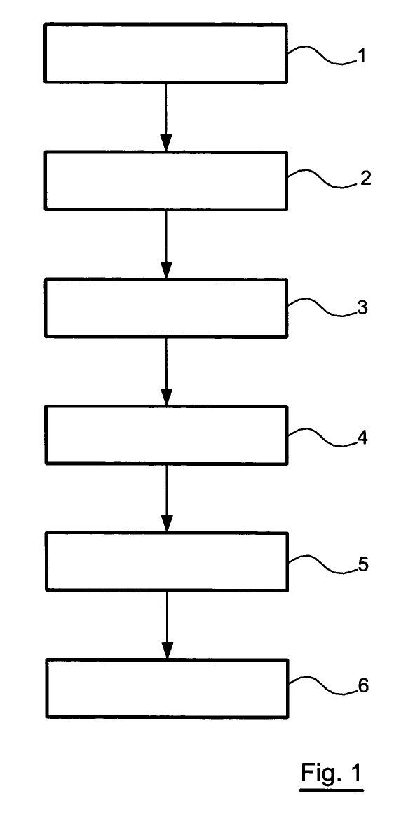

As illustrated in FIG. 1, in a particular embodiment, the method comprises the following steps:
the selection (1), from the set of indicators of a subset of indicators defining reduced profiles of individuals, of the reduced profile (also called a signature) of a given individual comprising, for the subset of indicators, values that are proper to this given individual and obtained from the data of a data warehouse;
the sampling (2) of the set of individuals enabling a sample of individuals called paragons to be obtained;
the obtaining (3) of a table of reduced profiles of paragons comprising, for each of the paragons, a reduced profile specific to this paragon;
the indexing (4) of all the individuals to the paragons, enabling the obtaining of an index linking each individual to at least one paragon whose reduced profile is the closest to the reduced profile of this individual. Thus, the content of the table of reduced profiles of paragons can be used for all the individuals;
the building (5) of at least one model of analysis based on the table of reduced profiles of paragons; and
the deploying (6) of the model of analysis, by the obtaining of scores and/or segments for the paragons from the table of reduced profiles of paragons, and then the generalization to all the individuals of the scores and/or segments obtained for the paragons, by means of the above-mentioned index.

Here below in the description, it is assumed by way of an example that the individuals are customers and the constitution of a table of reduced profiles of paragons is applied to the analysis of customer data. However, it is clear that the invention can also be applied to any other type of individual (product, communication call, transaction, IP address, etc.).

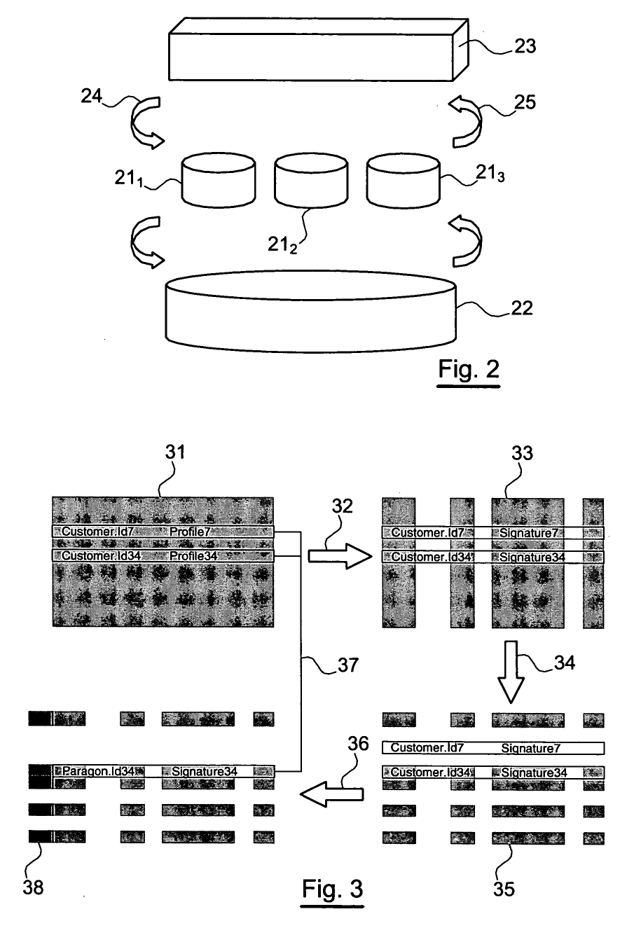

FIG. 2 shows a functional architecture illustrating the application of the method according to the invention to customer data analysis of this kind.

A table of reduced profiles of paragons (also called a paragon base) is built by professional application, in summarizing the detailed information contained in the large-scale consumer data warehouse 22. In FIG. 2, three paragon bases (referenced 21₁, 21₂ and 21₃) are built, for example for the following professional applications: loyalty, ADSL appetence, fraud etc.

The applications block (Ref 23) makes it possible to produce scores and exploit them operationally. The data-mining, reporting and campaign management tools constitute the applications block. The applications block 23 is connected to the paragon bases 21₁, 21₂ and 21₃ (summarized datamarts), which forms its information source.

The applications block 23 transmits a goal (referenced 24) in the form of a variable computed or evaluated on a sub-sample of the population. This target variable corresponds to a professional variable. For example, for a marketing campaign aimed at making a offer, a sample of the population would have been stimulated in order to determine its appetence with respect to this offer. The application block then sends forward the list of the values of the appetence to this offer on the sample.

The applications block 23 builds a model producing the scores on the sample where the goal variable is known. The model is then applied to the paragons. The index linking the paragons to all the individuals of the data warehouse enables retrieval of the scores (referenced 25) of all the individuals. Similarly, the applications block 23 can make a request on the paragon base to make a selection on all the customers of the data warehouse.

The fact that the datamarts are summarized is totally transparent to the applications block.

The volume of the data warehouse 22 is for example in the range of 100 terabytes. With the prior art technique, the potential volume of a table of profiles of all the individuals built from the detailed information reaches 10 terabytes. The use of the table summary technology according to the invention reduces the columns to 10 percent and the number of rows to 1 percent. So much so that for the same use of the table of profiles, the invention gives a volume of 10 gigabytes instead of 10 terabytes.

FIG. 3 illustrates the principle of the building of a table of reduced profiles of paragons according to the invention.

The upper left-hand quarter of FIG. 3 shows a table of profiles of all the customers 31, each row being specific to a given customer and comprising especially his identifier and all the indicators of his profiles (for example customer-ID7 and profile7 for the customer of row 7 and customer-ED34 and profile34 for the customer of row 34). It may be recalled that the invention summarizes this table of profiles of all the customers 31 without computing it.

The arrow referenced 32 symbolizes the step (referenced 1 in FIG. 1) for selecting a subset of indicators defining reduced profiles of individuals (also called signatures). The relevance of each indicator of the profiles is, for example, computed as a function of a target indicator (also called a goal variable) and the best indicators are selected to constitute the signatures. According to one variant, the subset of indicators selected is a pre-set list of indicators resulting from a selection of profession.

The upper right-hand quarter of the FIG. 3 represent the table of reduced profiles (or signatures) of all the individuals 33 resulting from the execution of the above-mentioned selection step. The selected indicators are seen in shaded portions and the others are seen in blank portions.

The arrow referenced 34 symbolizes the step (referenced 2 in FIG. 1) of sampling of the set of individuals by which it is possible to obtain a sample of individuals called paragons.

The lower right-hand quarter of FIG. 3 shows the table of reduced profiles (or signals (or signatures) of paragons 35 resulting from the execution of the above-mentioned sampling step. The rows specific to the paragons (members of the sample) are seen in the shaded portions and the others in the blank portions. Thus, to continue the above-mentioned example, it is assumed-that the customer of the row 34 is a paragon while the customer of the row 7 is not one.

The row referenced 36 symbolizes the indexing (4) step (referenced 3 in FIG. 1) for indexing (4) all the individuals on the paragons.

The lower left-hand quarter of FIG. 3 illustrates this indexing. For example, as symbolized by the arrow referenced 37, the customers of the rows 7 and 34 are both indexed to the customer of the row 34 who is a paragon.

The models are built and applied to the table of reduced profiles of paragons. The deployment of each model makes it possible for example to obtain scores for the paragons. At the lower left-hand quarter of FIG. 3, the scores are represented by the additional column 38, set before the table 35 of reduced profiles of paragons. Since all the individuals are indexed to the paragons, the deployment of the models comprises of a simple joining. In the above-mentioned example, the customer of the row 7 has the score of the paragon of the row 34, to which he is indexed, associated with him.

Referring now to FIG. 4, we present an architecture of the processing operations performed according to the invention to build a table of reduced profiles of paragons.

In order to enable the implementation of the table of reduced profiles of paragons in a very great volume, we use for example algorithms for processing information (namely data from the data warehouse 41) by sections of columns 42₁ to 42ₙ, for the indicator selection step (referenced 45) and by sections of rows 43₁ to 43ₙ and 44₁ to 44ₙ respectively for the sampling step (referenced 46) and the indexing step (referenced 47).

The table referenced 49 represents the subset of selected indicators resulting from the execution of the selection step 45. The table of reduced profiles of paragons 48 is obtained after execution of the sampling step 46 as a function of the subset of selected indicators 49. The table of reduced profiles of paragons 48 is then used during the indexing step 47.

An example of an embodiment of the indicator selection step (referenced 1 in FIG. 1, 32 in FIG. 3 and 45 in FIG. 4) is now presented in greater detail.

To select the indicators, a first random sample of the customers is made. In this sample of clients, about 10,000 variables (indicators) are made. These variables are computed from detailed data from the data warehouse. The MODL algorithm is used for example to discretize and give the importance of each variable taken independently as a function of an objective variable. Naturally, other selection algorithms may be used.

The MODL algorithm is described in detail in the following documents:

Boullé, M.: A Bayesian Approach for Supervised Discretization, Data Mining V, Eds Zanasi, Ebecken, Brebbia, WIT Press, (2004) 199-208;

Boullé, M.: A Grouping Method for Categorical Attributes Having Very Large Number of Values, Proceeding of the Fourth International Conference on Machine Learning and Data Mining in Pattern Recognition, (2005) 228-242.

This attribute selection and discretization method shows high-performance and low complexity: in o(m n log(n)), where m is the number of attributes and n the number of instances.

The indicator selection step produces at output:

M binary discretized indicators (M in the range of 1000 for example)

For each indicator Aᵢ, its computation formula F(Aᵢ).

For each indicator Aᵢ, its importance I(Aᵢ)

For each indicator Aᵢ, its support Sᵢ on the set S.

An example of an embodiment of the step for sampling individuals (referenced 2 in FIG. 1, 34 in FIG. 3 and 46 in FIG. 4) i.e. the paragon selection step, is now described in greater detail.

The paragon selection step is crucial. A paragon base with low representativity as regards customers could lead to the building of totally inefficient scores for the entire population. On the contrary a very large-sized paragon base would substantially reduce the utility of the use of summarizing technologies. It is therefore necessary to manage the compromise between the reduction of volume and the representativity of the base with the utmost efficiency.

The previous step, namely the column selection step (or indicator selection step) enables the identification of the variables that are interesting for a fixed goal. It is natural to use this information to build a representative sample.

In addition to the criterion of representativity, the algorithmic complexity is taken into account in order to remain within acceptable computation times.

This is why the method uses, for example, the algorithm Ease to build the sample satisfying the criterion of representativity in a single run.

The Ease algorithm is described in “Efficient Data reduction with Ease”, H. Brönniman, B. Chen, M. Dash, P. Haas, P. Scheuermann, proceedings of SIGKDD'03, Aug. 24-27, 2003.

An example of an embodiment of the indexing step (referenced 4 in FIG. 1, 36 in FIG. 3 and 47 in FIG. 4) i.e. the paragon selection step, is now described in greater detail.

The greater the number of paragons used, the higher will be the representativity of the sample. Resorting to techniques derived from “a stream-mining” will enable efficient approximate indexing even in the face of a very large number of paragons. These techniques are used to achieve mastery over the compromise between the precision desired for the result and the resources (in terms of time and memory) allocated to the algorithm. It may be recalled that, unlike a data warehouse for the archival storage of data, a datamart (summary) serves only for statistical analysis and can perfectly accept a certain degree of approximation.

For these reasons, one preferred embodiment chooses the LSH algorithm which gives an approximation of the “k closest neighbors” algorithm. The LSH algorithm is described in A. Gionis, P. Indyk, R. Motwani, “Similarity Search in High Dimensions via Hashing”, Proceedings of the 25th VLDB Conference, Edinburgh, Scotland, 1999.

To find the closest neighbor of a vector p, the LSH algorithm uses L hashing tables of M blocks containing at most B vectors. Each hashing table represents a dimensional selection of the vector p (for the building of the hashing tables, see the above-mentioned document describing the algorithm Ease). The candidates for the condition of closest neighbor of the vector p are the vectors contained in each of the L boxes corresponding to the L hashings of the vector p. An exhaustive search is made for these candidates to determine the closest neighbor or the k closest neighbors.

The critical point of the present application is that, to determine the paragon closest to a given customer, it is necessary to make a series of L×B random accesses to the table of the reduced profiles of paragons. In one particular implementation, this table is contained a random-access memory. If not, L×B disk accesses would be necessary, making the processing time prohibitive.

The indexing step produces an output index that can be used to link each customer to k paragons. Thus, all the computations made on the reduced table of paragons can be transposed to all the customers of the data warehouse.

For example, a given individual is assigned the score of the closest paragon to which he is indexed. If a given individual is indexed to several paragons, he is assigned a score obtained according to a determined decision policy (for example the score that is most assigned among the scores of the paragons concerned is taken or else an average of the scores of the paragons concerned is taken).

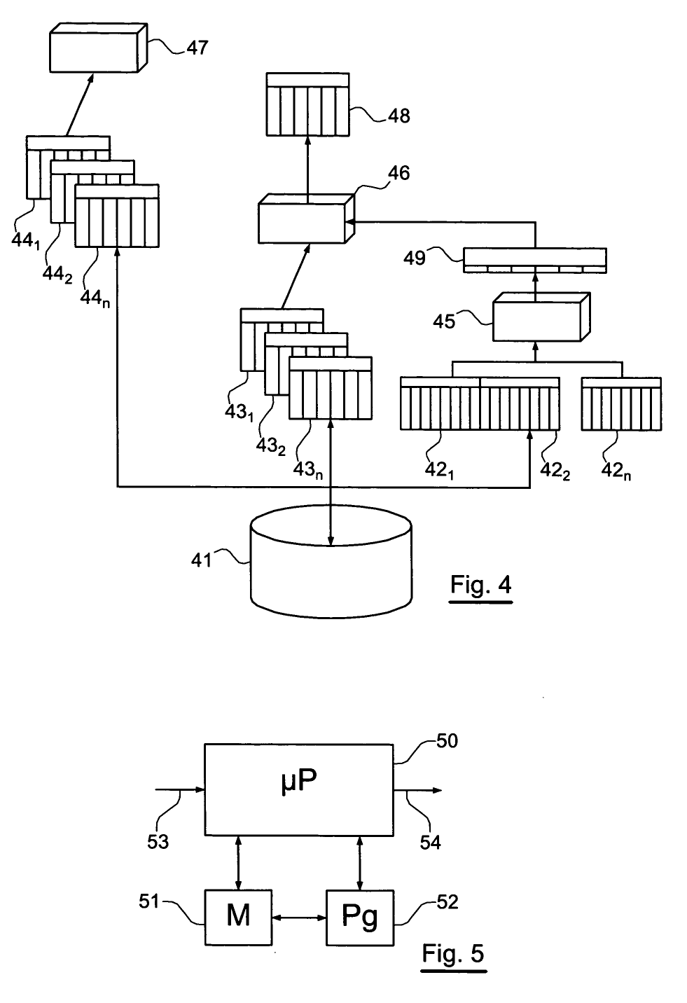

FIG. 5 shows the structure of a device according to the invention, enabling the building and use of a table of reduced profiles of paragons. This device includes a memory M 51, and a processing unit 50 equipped with a microprocessor μP, which is driven by a computer program Pg 52. The processor unit 50 receives at input the data 53 from a data warehouse which the microprocessor μP processes according to the instructions of the program Pg 52, 2 generate a table of reduced profiles of paragons 54 and, on the basis of this table, to build models and deploy them.

One or more embodiments described above overcome drawbacks of the prior art.

More specifically, one or more embodiments provide a data-mining technique to simplify and therefore reduce the cost of operations of data-storage and data-handling as well as the fine-tuning and deployment of models.

At least one embodiment provides a technique of this kind that includes the building and feeding of a datamart containing a table of profiles of all the individuals.

At least one embodiment provides a technique of this kind that can be used to obtain a highly open-ended system that costs very little to maintain as compared with a classic datamart corresponding to a table of profiles of all the individuals.

Although the present invention has been described with reference to preferred embodiments, workers skilled in the art will recognize that changes may be made in form and detail without departing from the spirit and scope of the invention.

What is claimed is:

1. A method for the building and use of a table of reduced profiles of paragons that enables the summarizing of a table of profiles of a set of individuals, all the profiles being defined by a same set of indicators, the profile of a given individual comprising values for said set of indicators that are proper to said given individual, said method comprising:
selecting, from the set of indicators, a subset of indicators defining reduced profiles of individuals, the reduced profile of a given individual comprising values for said subset of indicators that are proper to said given individual and obtained from the data of a data warehouse;
sampling the set of individuals, enabling a sample of individuals called paragons to be obtained;
obtaining a table of reduced profiles of paragons comprising, for each of the paragons, a reduced profile specific to said paragons; and
indexing all the individuals to the paragons, making it possible to obtain an index linking each individual to at least one paragon whose reduced profile is closest to the reduced profile of said individual, so that the content of the table of reduced profiles of paragons can be used for all the individuals.

2. The method according to claim 1, wherein the sampling step is performed as a function of the result of the selection step, so that the paragons represent all the individuals in said subset of indicators.

3. The method according to claim 1, wherein the step of selecting a subset of indicators comprises obtaining a predetermined list of pre-selected indicators.

4. The method according to claim 1, wherein the step of selecting a subset of indicators comprises computing the subset of indicators as a function of at least one determined target indicator.

5. The method according to claim 1, furthermore comprising building at least one analysis model based on the table of reduced profiles of paragons.

6. The method according to claim 1, furthermore comprising deploying a model of analysis, itself comprising:
obtaining scores and/or segments for the paragons from the table of reduced profiles of paragons; and
generalizing, to all the individuals, the scores and/or segments obtained for the paragon, through said index.

7. The method according to claim 1, wherein the selection step implements an algorithm enabling the processing of data from the data warehouse by sections of columns and the sampling and indexing steps implement algorithms enabling the processing of the data from the data warehouse by sections of rows.

8. A computer program product that can be downloaded from a communications network and/or recorded in a computer-readable carrier and/or executed by a processor, this computer program product comprising executable program code instructions for the execution of steps comprising:
building and use of a table of reduced profiles of paragons that enables the summarizing of a table of profiles of a set of individuals, all the profiles being defined by a same set of indicators, the profile of a given individual comprising values for said set of indicators that are proper to said given individual, including;
selecting, from the set of indicators, a subset of indicators defining reduced profiles of individuals, the reduced profile of a given individual comprising values for said subset of indicators that are proper to said given individual and obtained from the data of a data warehouse;
sampling the set of individuals, enabling a sample of individuals called paragons to be obtained;
obtaining a table of reduced profiles of paragons comprising, for each of the paragons, a reduced profile specific to said paragons; and
indexing all the individuals to the paragons, making it possible to obtain an index linking each individual to at least one paragon whose reduced profile is closest to the reduced profile of said individual, so that the content of the table of reduced profiles of paragons can be used for all the individuals.

9. A device for the building and use of a table of reduced profiles of paragons that enables the summarizing of a table of profiles of a set of individuals, all the profiles being defined by a same set of indicators, the profile of a given individual comprising values for said set of indicators that are proper to said given individual, said device comprising:
selection means enabling the selection, from the set of indicators of a subset of indicators defining reduced profiles of individuals, the reduced profile of a given individual comprising values for said subset of indicators that are proper to said given individual and obtained from the data of a data warehouse;
means for sampling the set of individuals, enabling a sample of individuals called paragons to be obtained;
means for obtaining a table of reduced profiles of paragons comprising, for each of the paragons, a reduced profile specific to said paragon; and
means for indexing all the individuals to the paragons, making it possible to obtain an index linking each individual to at least one paragon whose reduced profile is the closest to the reduced profile of said individual, so that the content of the table of reduced profiles of paragons can be used for all the individuals.
